(19) United States
(12) Patent Application Publication
(10) Pub. No.: US 2019/0098443 A1
(43) Pub. Date: Mar. 28, 2019

(54) GEOFENCE RETRIEVAL PRIORITIZATION

(71) Applicant: INTERNATIONAL BUSINESS MACHINES CORPORATION, Armonk, NY (US)

(72) Inventors: Lisa Seacat DeLuca, Baltimore, MD (US); Jeremy A. Greenberger, Raleigh, NC (US)

(21) Appl. No.: 15/718,776

(22) Filed: Sep. 28, 2017

(51) Int. Cl. H04W 4/02; G06F 17/30; G01S 19/42

(52) U.S. Cl. CPC H04W 4/021; G06F 17/30283; H04W 4/028; G01S 19/42; G06F 17/30241

(57) ABSTRACT

Systems, methods and tools to prioritize the retrieval of geofences by a client device as a function of the client device's movement and geofence expiration date. The geofence system calculates the amount of time it would take for the client device to reach a particular geofence. The geofence system determines that the amount of time for the client device to reach the virtual boundary of the geofence and whether it is impractical or impossible based on the current date and time, the expiration date and time of the geofence and the current or average movement speed of the of the client device. Under circumstances wherein the travel time to the boundary of the geofence would occur after the expiration date/time, the client device can automatically avoid the retrieval of said geofence.

### TECHNICAL FIELD

The present disclosure relates generally to systems, methods and tools for creating, receiving and displaying geofences.

### BACKGROUND

As portable devices, such as mobile communication systems, smart phones, tablet computers, laptops and navigation devices, become more advanced and powerful, these portable devices increasingly provide locational guidance to users in real time. More recently, portable devices have introduced a concept known as geo-fencing. A geofence is a virtual perimeter around a real-world location. Portable devices that implement geo-fencing functionalities may alert the user when the portable device has entered or exited an established geofence.

A geofence's perimeter may be virtually established around a point of interest such as an address, a store, a home, or any other location of interest. Programs that incorporate geo-fencing allow an administrator of a geofence to set up triggers so when a device enters (or exits) the boundaries of the geofence (defined by the administrator), a push notification, text message or email alert may be sent. Many geo-fencing applications incorporate Google® Earth, allowing administrators to define boundaries on top of a satellite view of a specific geographical area. Other applications may define boundaries by longitude and latitude or through user-created and Web-based maps.

### SUMMARY

A first embodiment of the present disclosure provides a method for prioritizing retrieval of geofences by a client device comprising the steps of querying, by a processor of the client device, a list of geofences, wherein each geofence in the list of geofences comprises a location, a size defined by a boundary, a payload and an expiration time; receiving, by the processor, location data of the client device; estimating, by the processor, an amount of time for the client device to travel to the boundary of each geofence in the list of geofences, as a function of the movement of the client device, the location data and the expiration time of each geofence; and retrieving, by the processor, each geofence from the list of geofences having an amount of time for the client device to travel to the boundary of the geofence that is less than the expiration time of the geofence.

A second embodiment of the present disclosure provides a computer system, comprising a processor; a memory device coupled to the processing unit; a measuring device or sensor; and a computer readable storage device coupled to the processor, wherein the storage device contains program code executable by the processing unit via the memory device to implement a method for prioritizing retrieval of geofences comprising the steps of: querying, by the processor, a list of geofences, wherein each geofence in the list of geofences comprises a location, a size defined by a boundary, a payload and an expiration time; receiving, by the processor, location data of the computer system; estimating, by the processor, an amount of time for the computer system to travel to the boundary of each geofence in the list of geofences, as a function of the movement of the computer system, the location data and the expiration time of each geofence; retrieving, by the processor, each geofence from the list of geofences having an amount of time for the computer system to travel to the boundary of the geofence that is less than the expiration time of the geofence.

A third embodiment of the present disclosure provides a computer program product comprising: one or more computer readable hardware storage devices having computer readable program code stored therein, said program code containing instructions executable by the one or more central processing units (CPU) to implement a method for prioritizing retrieval of geofences comprising the steps of: querying, by the CPU, a list of geofences, wherein each geofence in the list of geofences comprises a location, a size defined by a boundary, a payload and an expiration time; receiving, by the CPU, location data of the computer system; estimating, by the CPU, an amount of time for the computer system to travel to the boundary of each geofence in the list of geofences, as a function of the movement of the computer system, the location data and the expiration time of each geofence; retrieving, by the CPU, each geofence from the list of geofences having an amount of time for the computer system to travel to the boundary of the geofence that is less than the expiration time of the geofence.

### BRIEF DESCRIPTION OF THE DRAWINGS

FIG. 1 depicts a schematic view of an embodiment of a system for prioritizing geofence retrieval and deletion consistent with the embodiments of the present disclosure.

FIG. 2 depicts a schematic view of an alternative embodiment of a system for prioritizing geofence retrieval and deletion from the geofence server side consistent with the embodiments of the present disclosure.

FIG. 3 illustrates a schematic view of an embodiment of a system for prioritizing geofence retrieval and deletion operating in a cloud computing environment.

FIG. 4 illustrates a schematic view of an embodiment of the abstraction layers of a cloud computing environment.

FIG. 5 illustrates an embodiment of a geofence management system creating a first geofence having a first set of defined parameters including an expiration date and time.

FIG. 6 illustrates an embodiment of a geofence management system creating a second geofence having a second set of defined parameters including a second expiration date and time.

FIG. 7 illustrates an embodiment of a geofence management system creating a third geofence having a third set of defined parameters including a third expiration date and time.

FIG. 8 illustrates an embodiment of a mapping interface tracking locations of the client device relative to one or more geofences.

FIG. 9 illustrates an embodiment of a client device displaying one or more geofences retrieved from the geofence management system and omitting the retrieval of one or more geofences as a function of the traveling time and the expiration date/time of the omitted geofence.

FIG. 10 illustrates a payload as a function of a client device entering the boundary of a geofence and displaying the payload of the geofence.

FIG. 11 depicts an embodiment of a client device omitting the retrieval or removing one or more geofences from the mapping interface as a function of the traveling time and the expiration date/time of the omitted geofence.

FIG. 12 depicts an embodiment of an algorithm used for prioritizing geofence retrieval and/or deletion.

FIG. 13 depicts an embodiment of a computing system consistent with the computer systems of the present disclosure.

### DETAILED DESCRIPTION

### Overview

Embodiments of the present disclosure recognize that currently available geofence systems and client devices retrieving the geofences may be limited to a preset number of geofences that may be loaded into a single client device and/or displayed by the client device. Client devices, such as computer systems and mobile computing systems operating on the Android operating system, may be limited to retrieving and storing 100 simultaneous geofences. Likewise, mobile computing devices equipped with Apple's iOS operating system may be limited to merely 20 simultaneous geofences stored or accessible to the client device retrieving the geofences.

Often, the number of geofences available for retrieval and download onto the client device in a current location may exceed the maximum number of geofences that can be simultaneously stored and displayed by the client device. Accordingly, because of the limitations on the number of geofences by the operating systems of client devices, there is a need to prioritize the order in which active geofences are distributed and transmitted to the client devices by the server or client device managing the distribution of the geofences. Prioritizing the order active geofences are retrieved by the client device may ensure that the geofences retrieved and stored by client devices are likely to be activated before the expiration time of the geofence.

Embodiments of the present disclosure may exclude or prevent geofences from being retrieved or downloaded by a client device that would be unlikely or impossible to activate by the client device before the expiration of the geofence. The geofence system of the present disclosure may be able to use the location data of the client device, traveling speed of the client device (or use an average speed) measured by one or more sensors or devices and calculate the amount of time the client device may need to travel to geofences currently available to the client device for retrieval. The geofence system of the present disclosure may further compare the traveling time needed to arrive at a particular geofence with the current time and the expiration time of the geofence. Under circumstances wherein the geofence system determines that the client device would not be likely to or could not possibly activate the geofence before the expiration date/time, the client device and/or the geofence management system may prevent the retrieval of the geofence or delete the geofence from the client device (if the geofence had been previously retrieved).

Accordingly, by preventing the retrieval of all available geofences automatically and instead selectively retrieving geofences based on the ability of the client device to reach the boundary of the geofences before expiration, the geofence system described herein may improve the operation of the client device itself, including improvements to the hardware and/or software (i.e. the operating system). For example, if a geofence is downloaded to a client device and the geofence is triggered through an entry/exit/dwell event, the client device uses a certain amount of the client device's memory, processing capacity, and increases power consumption to track the movement of the client device and report back to a listening service such as a tracking module of a geofence management system. If a geofence is active but unreachable before the expiration date and/or no longer active (but occupying memory space), maintaining the unreachable or inactive geofence stored by the client device becomes wasted computing resources for the client device. Whereas, downloading geofences that are accessible to the client device before the expiration date will not needlessly waste computing resources such as processing capacity, memory and power, but rather efficiently budget resources for each accessible geofence that may be triggered by the client device.

Furthermore, in a geofence system that does not selectively download geofences, an active geofence that was not downloaded due to the client device reaching the maximum number of geofences able to be loaded into an operating system may be ignored because an inactive geofence or unreachable geofence has taken the available geofence's place. Whereas, in the disclosed system, the operating system of the client device is improved significantly because only active and accessible geofences are downloaded and maintained by the client device. Inactive or inaccessible geofences are ignored or removed from the client device automatically, thus allowing the client system to apply computing resources for maintaining accessible geofence instead of wasting resources on inaccessible or inactive geofence.

### System for Prioritizing Retrieval of Geofences

Although certain embodiments are shown and described in detail, it should be understood that various changes and modifications may be made without departing from the scope of the appended claims. The scope of the present disclosure will in no way be limited to the number of constituting components, the materials thereof, the shapes thereof, the relative arrangement thereof, etc., and are disclosed simply as an example of embodiments of the present disclosure. A more complete understanding of the present embodiments and advantages thereof may be acquired by referring to the following description taken in conjunction with the accompanying drawings, in which like reference numbers indicate like features.

As a preface to the detailed description, it should be noted that, as used in this specification and the appended claims, the singular forms “a”, “an” and “the” include plural referents, unless the context clearly dictates otherwise.

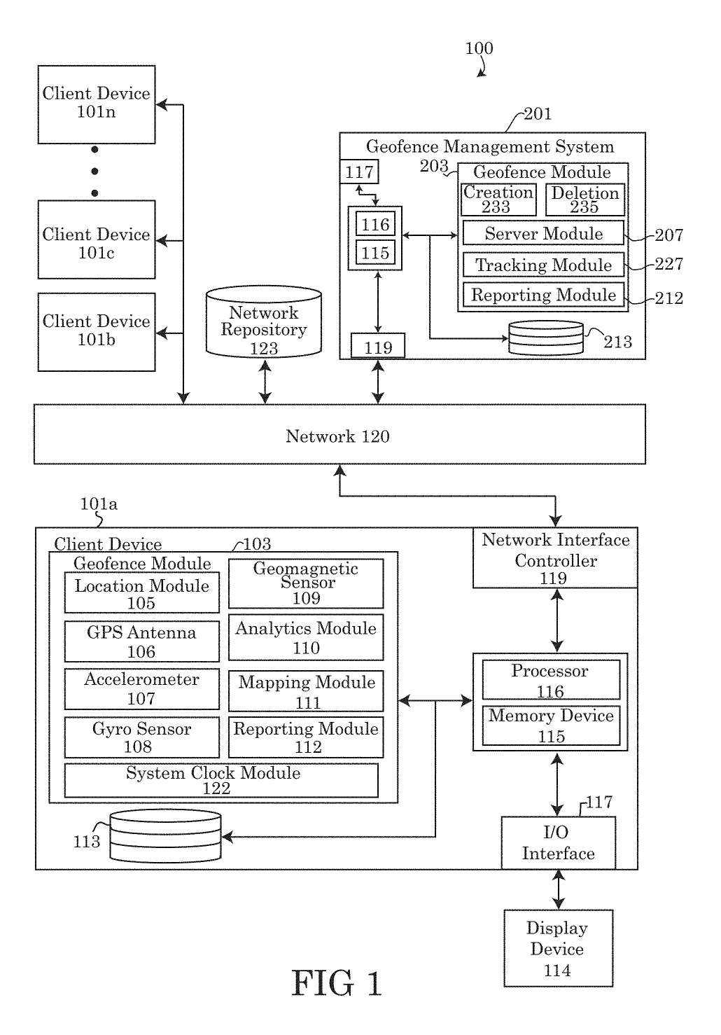

Referring to the drawings, FIG. 1 depicts a block diagram of a geofence system 100 capable of prioritizing the retrieval of geofences by one or more of the client devices 101a, 101b, 101c . . . 101n (referred to collectively as “client device 101”) or the transmission of geofences from a geofence management system 201 to each client device 101 requesting one or more geofences. Embodiments of the computer systems within the geofence system 100, such as the Client device 101 and geofence management system 201, may be herein referred to as computing systems 101, 201 and/or as specialized computing systems 101, 201. Embodiments of the geofence system 100 may include a plurality of one or more computer systems 101, 201 including one or more client devices 101a, 101b, 101c . . . 101n, geofence management systems 201 and network accessible devices, including hardware devices and data storage devices such as the network repository 123. The number of client devices 101, network accessible devices and geofence management systems 201 may not be limited to the number of devices depicted in the drawings. The number of client devices 101, geofence management systems 201 and network accessible devices may be any number of computer systems or hardware that may be supported and/or connected to network 120.

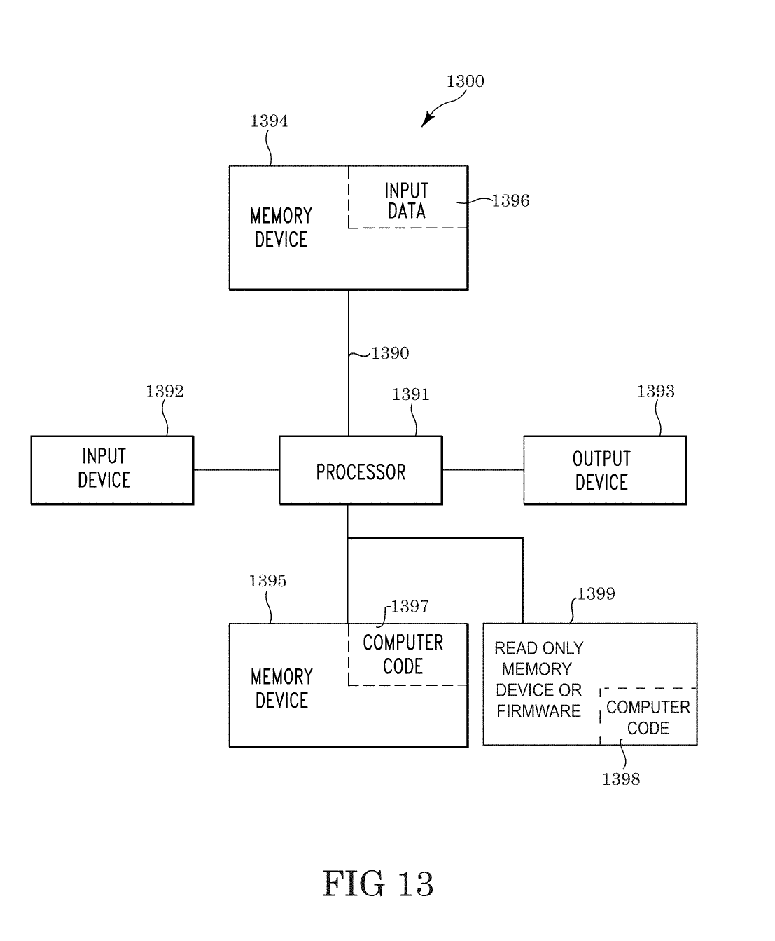

Each of the computer systems 101, 201 and network accessible devices (such as network repository 123) connected to the network 120 of the geofence system 100 may each be specialized computer systems 101, 201 comprising specialized configurations of hardware, software or a combination thereof as depicted in FIGS. 1-12 of the present disclosure and in the embodiments described herein. Embodiments of each of the computer systems 101, 201 connected to the geofence system 100 may not only comprise the elements of the systems and devices depicted in FIG. 1-12, but may also incorporate one or more elements of a generic computer system 1300 as shown in FIG. 13 and as described in the COMPUTER SYSTEM section in detail below. One or more elements of the computer system 1300 of FIG. 13 may be integrated into the specialized computer systems 101, 201 of the client device 101 or geofence management system 201 of FIGS. 1-12.

Each of the computer systems 101, 201 and the network accessible devices such as the network repository 123, may each be connected and placed in communication with one another over the computer network 120. Embodiments of the network 120 may be constructed using wired or wireless connections. As shown in the exemplary embodiments, each client device 101 and geofence management system 201 may connect to the network 120 and communicate over the network 120 using a network interface controller (NIC) 119 or other network communication hardware. Embodiments of the NIC 119 may implement specialized electronic circuitry allowing for communication using a specific physical layer and a data link layer standard. For example Ethernet, Fiber channel, Wi-Fi or Token Ring.

The NIC 119 may further allow for a full network protocol stack, enabling communication over network 120 to the group of computer systems or other computing hardware devices linked together through communication channels. Embodiments of the network 120 may facilitate communication and resource sharing among the computer systems 101, 201 and the additional hardware devices connected to the network 120, for example a network accessible repository 123. Examples of network 120 may include a local area network (LAN), home area network (HAN), wide area network (WAN), back bone networks (BBN), peer to peer networks (P2P), campus networks, enterprise networks, the Internet, cloud computing networks and any other network known by a person skilled in the art.

In some embodiments, the network 120 may be operating as a cloud computing environment 50. Cloud computing is a model of service delivery enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models. The characteristics of the cloud computing model may be described as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

The service models under a cloud computing environment may be described as follows:

Software as a Service (SaaS): the capability provided to the consumer is to use the provider's applications running on a cloud infrastructure. The applications are accessible from various client devices 54A, 54B, 54C . . . 54N through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

The deployment models of cloud computing environments may be described as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

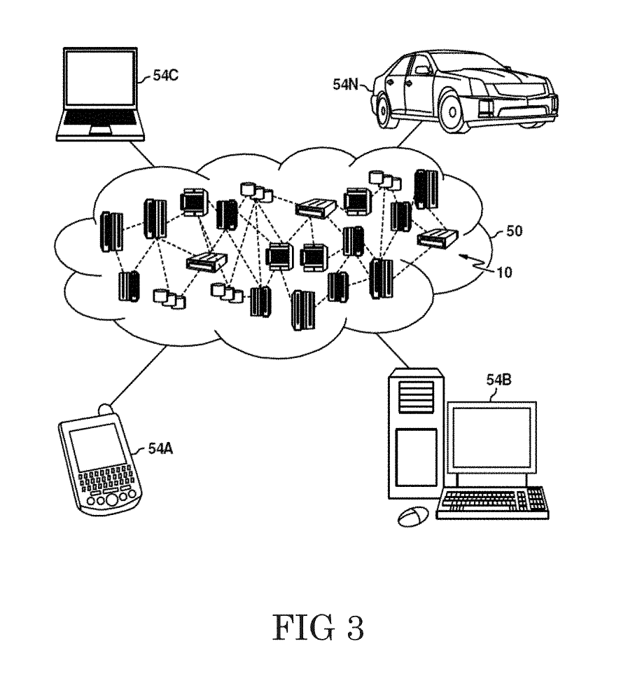

A cloud computing environment 50 may be service oriented with a focus on statelessness, low coupling, modularity, and semantic interoperability. At the heart of cloud computing is an infrastructure that includes a network of interconnected nodes 10. Referring to the drawings, FIG. 3 is illustrative of a network 120 operating as a cloud computing environment 50. As shown, the cloud computing environment 50 may include one or more cloud computing nodes 10 with which client devices 101 used by cloud consumers, such as, for example, desktop computers 54b, laptop computers 54c, and mobile communication devices 54A, tablet computers or computer systems integrated into devices 54N as exemplified by the vehicle shown in FIG. 3.

Each node 10 may communicate with one another or may be grouped (not shown) physically or virtually, in one or more networks, such as Private, Community, Public, or Hybrid clouds as described hereinabove, or a combination thereof, allowing for the cloud computing environment 50 to offer infrastructure, platforms and/or software as services for which a cloud consumer does not need to maintain resources on each client device 101. It is understood that the types of client devices 101 as shown in FIGS. 1-12 are intended to be illustrative only and that nodes 10 of a cloud computing environment 50 can communicate with any type of computerized device over any type of network and/or network addressable connection (e.g., using a web browser).

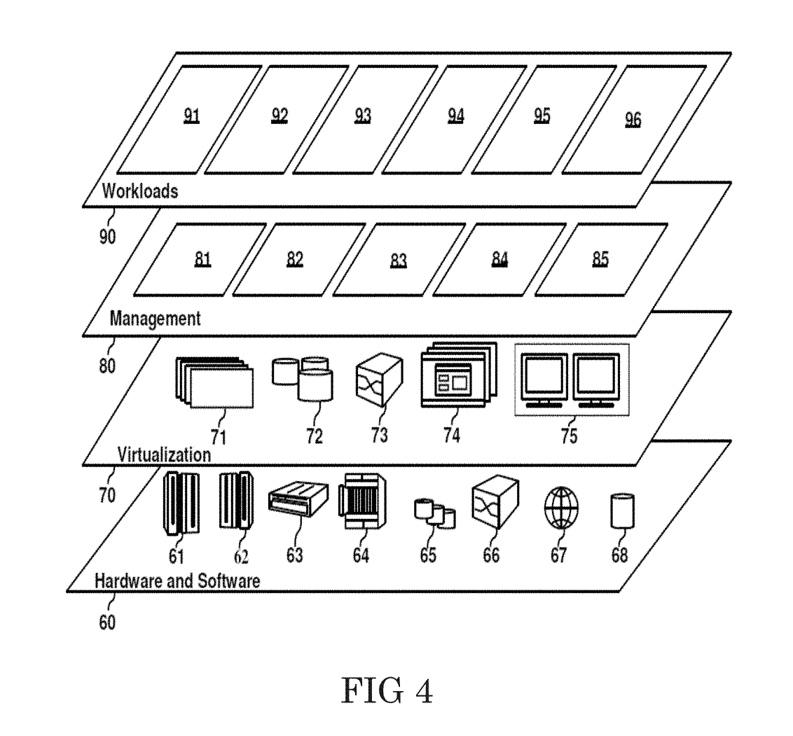

Referring now to FIG. 4, a set of functional abstraction layers provided by a cloud computing environment 50 of the network 120 is shown. It should be understood in advance that the components, layers, and functions shown in FIG. 4 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networking components 66. In some embodiments, software components may include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

Embodiments of the management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment 50 of the network 120 for consumers (i.e. geofence creators and users) and system administrators. Service level management 84 provides cloud computing resource allocation and management such that required service levels are met. Service Level Agreement (SLA) planning and fulfillment 85 provides pre-arrangement for, and procurement of, cloud computing resources for which a future requirement is anticipated in accordance with an SLA.

Workload layer 90 provides examples of functionality for which the cloud computing environment 50 may be utilized. Examples of workloads and functions which may be provided from this layer include: records management 91; web page management 92; searching and results management 93; data analytics processing 94; profile management 95; and geofence management 96.

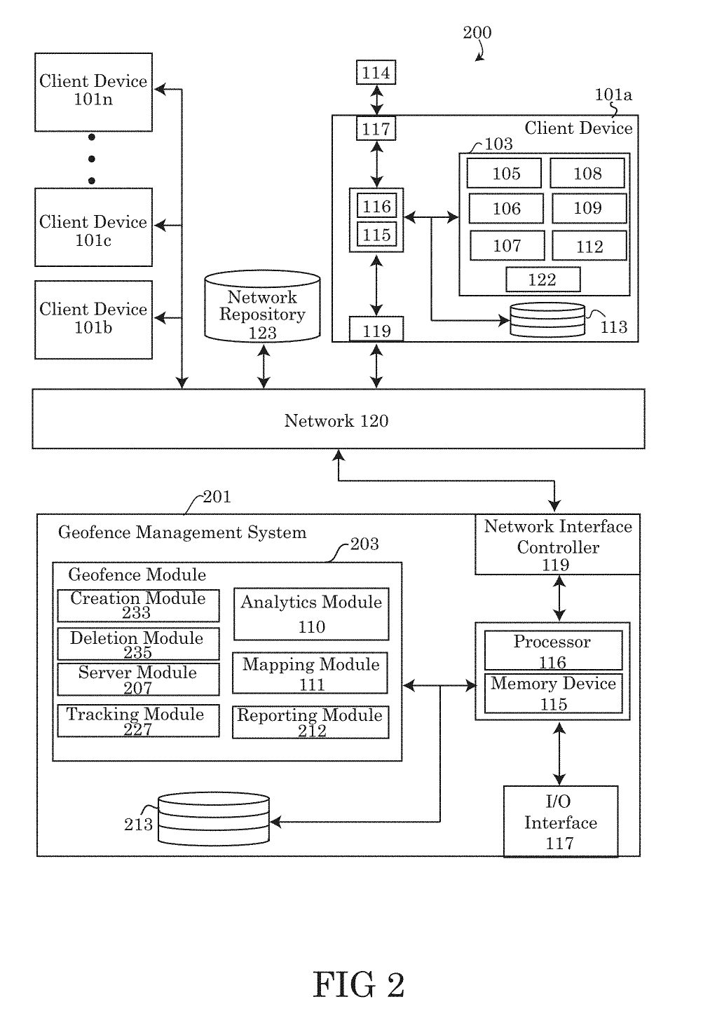

In some embodiments of the geofence system 100, the system 100 may include one or more client devices 101 connected to a geofence management system 201 via the computer network 120 as shown in the geofence system 100 schematic of FIG. 1-2. A client device 101 may be any type of computing system that may be capable of moving or changing locations. Some examples of client devices 101 may include, but are not limited to mobile communication devices, smart phones, cell phones, laptops, tablet computers, smart watches, smart glasses, personalized data assistants (PDA) and wireless or internet enabled media devices. In some embodiments, the client devices 101 may be any type of touch point device capable of acting as a point of interaction with the geofences created by the geofence management system 201 (described below). The client devices 101 are not limited only to the number of devices depicted in the figures of the current application, any number of client devices 101 may part of the geofence system 100 and connected to network 120. The number of client devices 101 connected to the network 120 may be open ended.

Embodiments of the client devices 101 may include a geofence module 103 as shown in FIG. 1. The geofence module 103 may selectively download and interact with active geofences created by the geofence management system 201 depending on the parameters of each geofence, and more specifically the expiration date and time in some embodiments. The geofence module 103 may include specialized hardware physically connected or integrated into the client device 101, a software program or program instructions loaded in the memory device 115 of the client device 101 or separate hardware or software interacting with the client device 101. In alternative embodiments, the geofence module 103 providing access to each of the active geofences may be virtualized hardware that may be physically accessible via network 120 or remotely accessible via a program executing program instructions for transmitting, receiving and displaying the data of the geofences (and associated geofence payload). For example, the client device 101 may be accessing a virtualized geofence module 103 through program or application services maintained by a cloud computing network and accessed via network 120.

Embodiments of the computer systems 101, 201 may each include a geofence module 103, 203. The term “module” may refer to a hardware based module, software based module or a module may be a combination of hardware and software resources. A module (whether hardware, software, or a combination thereof) may be designed to implement or execute one or more particular functions, tasks or routines of the computer systems 101, 201. Embodiments of hardware based modules may include self-contained components such as chipsets, specialized circuitry and one or more memory devices 115, 1395. A software-based module may be part of a program code or linked to program code containing specific programmed instructions loaded in the memory device 115 of the specialized computer systems 101, 201 of the geofence system 100.

Embodiments of the geofence module 103 may include a location module 105. The location module 105 may be comprised of hardware and/or software capable of utilizing a positioning system to pinpoint the current location of the client device 101 and/or previously stored locations of each client device 101 that may be saved to the memory device 115 or database 113. The location module 105 may retrieve and store the location of the client device as location data (for example as coordinates). In some embodiments, the location module 105 may include a transmitter, receiver and/or transceiver for receiving location data from a positioning system or broadcasting the location data to a geofence management system 201. Embodiments of the location module 105 may utilize the positioning capabilities of the global positioning system (GPS) using a GPS antenna 106. In alternative embodiments positioning systems may use Wi-Fi, Bluetooth or Bluetooth low energy beacons, cell tower triangulation, other positioning systems known by those skilled in the art or a combination of positional systems thereof. Embodiments of the location module 105 may save, store and update one or more sets of location data to a memory device 115 onboard the location module 105 or the location module 105 may store the location information to a separate memory device 115 or database 113.

Embodiments of the location module 105 may communicate the stored location data of the client device 101 to the geofence management system 201 in order to allow the tracking module 227 to keep track of the location of each client device 101 in communication with the geofence management system 201. The geofence management system 201 may compare the location data with the established geofences, collect relevant data about each client device 101 or the device's user entering, exiting or dwelling within the established geofences and deliver a payload (such as a push notification) to the client devices 101 meeting the transitioning conditions of the geofence prior to the expiration date and time designated by the geofence's parameters.

Embodiments of the client device 101 may comprise additional hardware or software modules capable of calculating the amount of time the client device 101 may take to reach a particular geofence available to the client device 101 for download or retrieval. One or more components may be incorporated into the client device or placed into electronic communication with the client device 101 which may be able to estimate the amount of time a client device may minimally require to reach the boundary of an available geofence and/or identify the type of transportation being utilized by the user to travel toward one or more geofences. Examples of some possible measuring devices and sensors are depicted in FIG. 1-2 of the geofence system 100, 200 to measure physical forces may include an accelerometer 107, gyro sensor 108 (a gyroscope sensor), or geomagnetic sensor 109 (collectively referred to as “measuring components 107, 108, 109”). Furthermore, based on the measurements of the measuring components 107, 108, 109 the analytics module 110 (described below) may further be able to identify the mode of transportation being used by the user of the client device 101. For instance, the analytics module 110 may be able to determine that the user of a client device 101 is walking, bicycling, using an automobile, train, plane, etc. and therefore anticipate the length of travel time needed to reach each geofence

Embodiments of the measuring components 107, 108, 109 may be integrated into the client device 101 in some embodiments as shown in FIG. 1-2, wherein the measuring components 107, 108, 109 are integrated into the client device as part of the geofence module 103. In alternative embodiments, the measuring components 107, 108, 109 may be part of separate computing systems or devices capable of obtaining measurements of physical forces associated with one or more measuring components 107, 108, 109. The measuring components 107,108, 109 may interface with the client device 101 or transmit the measurement data collected by the measuring components 107, 108, 109 to the client device 101 and/or geofence management system 201. In yet another alternative embodiment, the measuring components 107, 108, 109 may be a combination of modules integrated into the client device 101 and/or a third party device separate from the client device 101.

Each of the measuring components 107, 108, 109 may measure a physical force or a change in a force relevant to estimating the amount of time to travel to one or more of the geofences available for retrieval by the client device 101. Use and analysis of the recorded measurements obtained by the measuring components 107, 108, 109 may assist with estimate the amount of time a client device 101 may take to travel to a particular geofence. For example, an accelerometer 107 may be a device that may measure acceleration (i.e. a rate of change in velocity). As the client device 101 or separate third party device comprising the accelerometer 107 undergoes a change in velocity, the accelerometer 107 may measure the acceleration that the client device 101 is experiencing and record the measurement from the accelerometer 107.

The amount of acceleration being measured and stored as measurement data may be accessible to the analytics module 110 of the client device 101 or geofence management system 201, allowing for the analytics module 110 to draw conclusions about the length of travel time based on the current location of the client device 101, the location of the geofence boundary, the distance between the client device and geofence and how quickly the client device may reach the geofence as a function of the acceleration experienced by the accelerometer 107. The acceleration values may be collected, recorded in a database 113 or network accessible repository 123 and further transmitted to the analytics module 110 for further analysis. For example, based on the current rate of speed being measured by the accelerometer 107, an estimated time of arrival at the geofence may be calculated. The estimated time of arrival of the client device 101 to the location of the geofence may identify whether or not there is a possibility that the geofence can even be activated by the client device 101. If the estimated time of arrival is expected to occur after the expiration date and time of the geofence, the analytics module 110 may conclude that the client device 101 should not retrieve the geofence due the impossibility or impracticability of even being able to activate said geofence.

In some embodiments, one or more of the measuring components 107, 108, 109 may include a gyro sensor 108 for measuring travel time and arrival time of the client device 101 to a geofence location. A gyro sensor 108 may be a hardware device or software capable of sensing angular velocity, rotational motion and/or changes in orientation. Embodiments of a gyro sensor 108 may measure the amount of angular velocity being produced by a motion itself, and sense angular velocity produced by the movement of the sensor. Angles of the motion may be detected by integration operations carried out by a processor 116 as the angles move and are reflected in an application or by sensing vibrations produced by external environments around the gyro sensor 108 to correct the orientation of the object embedded with the gyro sensor 108 (i.e. the client device 101 or a third party device).

Similar to the accelerometer 107 described above, the measurements recorded by the gyro sensor 108 may also be stored in a database 113, network accessible repository 123 or other data storage device. The measurements collected by the gyro sensor 108 may be transmitted to an analytics module 110 of either the client device 101 or geofence management system 201, wherein the measurements may be further analyzed in order to provide an accurate estimation for an arrival time to a particular geofence available for retrieval or previously retrieved by the client device 101.

In some embodiments of the client device 101, the geofence module 103 may comprise a geomagnetic sensor 109. Similar to the accelerometer 107 and the gyro sensor 108, the geomagnetic sensor 109 may also collect measurements of one or more physical forces experienced by the client device 101 or a by a separate third party device in communication with the client device 101, in order to estimate the amount of time needed for the client device 101 to reach a particular geofence from the client device's 101 current location. Embodiments of the geomagnetic sensor 109 may determine an orientation of the client device 101 or a third party device in electronic communication with client device 101, based on the earth's magnetic field. A geomagnetic sensor 109 may enable accurate directional pointing for map orientation and navigation. When combined with an accelerometer 107 and a GPS antenna 106, the client device's 101 movements may be accurately tracked in real time and compared with the expected or simulated movement of a client device 101 of a user to calculate an estimated travel time to the boundary of the geofence. For example, in some embodiments, the client device 101 may estimate the amount of time for the client device 101 to travel to the boundary of one or more active geofences by using a GPS route presenting travelling directions and a calculated amount of time for reaching the destination of each available geofence.

Embodiments of the geofence module 103 of the client device 101 may, in some instances further comprise a system clock module 122. Embodiments of the system clock module 122 may perform the function of tracking the current date and time on the client device 101. The system clock module 122 may provide a reference for the current date and time and an estimated time of the system clock after undergoing an estimated travel time to move from the client device's current location to the location of the selected geofence boundary. In some embodiments, the system clock module 122 may simply report the current date and time to the analytics module 110, allowing for the analytics module 110 to conclude whether or not the client device 101 may reach the geofence boundary before the geofence expires.

In alternative embodiments, the system clock module 122 may perform the function of comparing the system clock module's 122 estimated time after a projected amount of travelling is expected to occur in order to reach the geofence having a particular geofence expiration date and time. The system clock module 122 in some embodiments may identify whether or not the expected arrival of the client device 101 at the geofence boundary will occur after the expiration of the geofence. The system clock module 122 may forward expected arrival information and/or one or more calculated conclusion to the analytics module 110 for further analysis and/or action to be taken by the client device 101. For example, upon the conclusion by the system clock module 122 that the estimated time after traveling to the boundary of the geofence would be a time after the expiration date/time of the geofence, the system clock module 122 may alert the analytics module 110 and/or the reporting module 112, resulting in the overall decision automatically by the client device or manually by the user of the client device to not retrieve or download the particular geofence calculated to expire before the client device 101 may travel to the geofence's location.

Embodiments of the geofence module 103 may further comprise an analytics module 110. The analytics module 110 may perform the function or task of analyzing location data collected by the location module 105, measurements collected by the measurement components 107, 108, 109 and date and time information stored by the system clock module 122. Using the location data, the measurements and date and time information, the analytics module 110 may draw one or more conclusions about the ability of the client device 101 to activate one or more geofences as a function of all the data available before the expiration date and time of the geofence. In some embodiments, the analytics module 110 may even add an additional padding time to the estimated travel time or the expiration time to further compensate for adjustments to the travel speed, traffic or just to generally ensure that geofences are retrieved unless fairly certain the geofence could not be activated in time.

Geofences that may be reached and activated by the client device 101 before the expiration of the geofence (with or without the padding time) may be retrieved from the geofence management system 201 and downloaded to the client device 101, whereas geofences that may be expiring before the client device could reach the geofence may not be retrieved or prevented from being retrieved by the client device 101 or the geofence management system 201. Each of the conclusions determined by analytics module 110 may be stored in one or more databases 113, 213, network repositories 123, memory devices 115 or transmitted to the geofence management system 201. Based on the determination of which geofences are accessible before the expiration of the geofence, each accessible geofences may be retrieved and downloaded. For each geofence retrieved, a geofence's payload may be displayed on the display device 114 of the client device 101 if the client device 101 triggers the retrieved geofence by moving to the location of virtual boundary of the geofence before the geofence expires. A payload may refer to a part of the data transmitted to the client device 101 that is the actual intended message. Embodiments of the payload may exclude headers or metadata that may be for the purpose of facilitating payload delivery. For example, the embodiments of the payload may include messages, graphics, videos, coupons with bar codes, interactive computer elements or any other information that may be presented via an activated geofence.

In some embodiments of the client device 101, the client device 101 may further comprise a mapping module 111. The mapping module 111 may perform the function of plotting the client device's 101 location and monitoring the changes in the position of the client device 101 in real time as the user of the client device 101 changes locations while transporting the client device 101. Embodiments of the mapping module 111 may retrieve the geofence data of currently active geofences from the geofence management system 201 for each active geofence that may be determined to be reachable by the client device 101 before the expiration of the geofence.

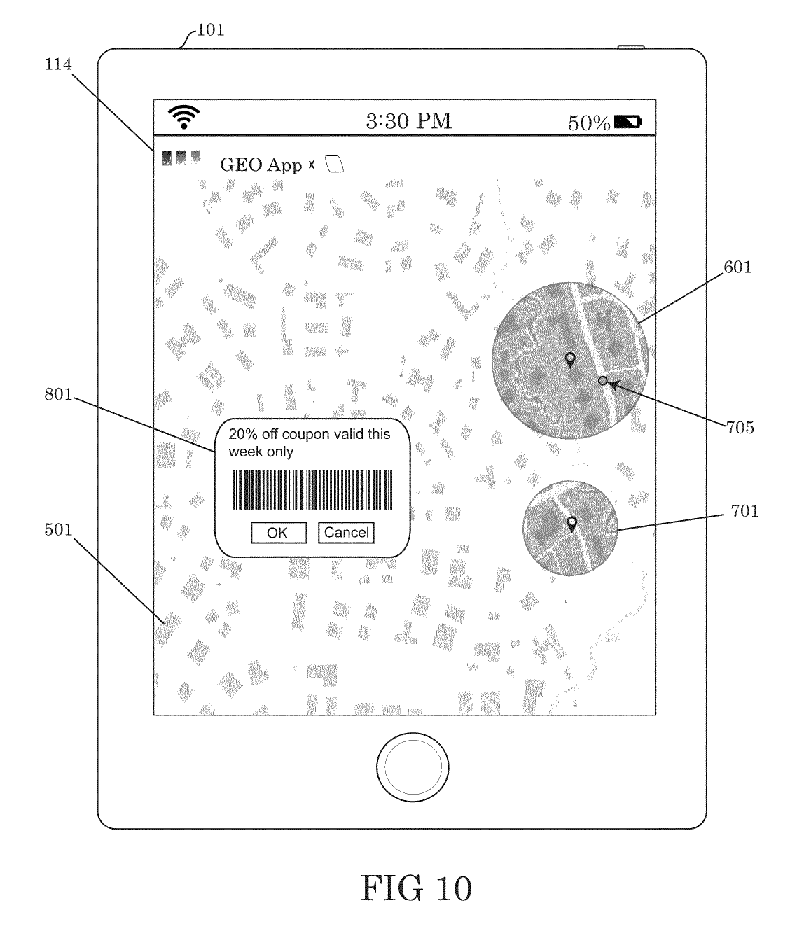

In some embodiments, the mapping module 111 may download or retrieve updated geofence data from the geofence server module 207 responsible for distributing the geofence data to each of the client devices 101. The client device's 101 mapping module 111 may plot each of active geofences as a function of the geofences' data onto a mapping interface 501. In some embodiments, the mapping interface 501 may or may not display the geofences' virtual barriers. Instead, the virtual barriers of the geofence may be hidden and may display a designated geofence's payload upon triggering a geofence loaded by the mapping module 111 onto a mapping interface 501 when a user's client device 101 enters the location of the geofence during the active geofence time frame designated by the geofence's parameters. If the client device 101 enters the geofence prior to the expiration date and time of the geofence set by the parameters of the geofence, once the geofence is active, the reporting module 112 of the geofence module 103 may display the geofence's payload on the display device 114 of the client device 101. For example, as shown in FIG. 10, the geofence's payload 801 may displayed as part of the mapping interface 501.

As mentioned above, in some embodiments of the geofence system 100, the geofence system 100 may include a geofence management system 201. The geofence management system 201 may perform the functions, tasks and services of system 100 directed toward creating, deleting, tracking and serving a geofence to one or more client devices 101. The geofence management system 201 may be used to define the properties of the geofence including the geofence's location, size, payload, start date and time, and expiration date and time. The geofence management system 201 may select configuration information of the geofence during each geofence setup, link the geofence to a period of activation (the period of time between the start date and expiration date), link a marketing campaigns containing geofence payload or individually customized geofence payloads to the geofence, and deliver geofence payload to the one or more client device 101 encountering the geofences prior to the expiration date and time of the geofence.

Embodiments of the creation module 233 of the geofence management system 201 may perform the task of generating and configuring one or more geofences. The creation module 233 may allow a user or an administrator to input the desired configuration settings for each of the geofences being created. The creation module 233 may receive configuration settings being be inputted directly into the geofence management system 201 or from a remotely accessible computer system connected to the geofence management system 201 via network 120. For example, a request to build each of the geofences to a particular specification may be received by the geofence management system 201 in the form of an API call. The API call may be loaded into the memory device 115 of the geofence management system 201. The creation module 233 may analyze configuration settings of the geofence being created as requested by the geofence creator and the geofence management system 201 may confirm the settings are feasible or error free.

If the configuration settings for geofence are not feasible or contain errors, the geofence creation module 233 may deny the request and further request a correction of the errors. For example, the creator of the geofence may have forgotten to an expiration date or time for the geofence. The geofence management system 201 may identify and report an error and request a correction to the configuration settings and parameters of the geofence. Otherwise, if the configuration settings are feasible and error free, the creation module 233 may build the geofence according to the requested parameters, including the requested duration, expiration date, start time, start date, end time, end date, location, size, virtual boundary shape, the applicable transitions for triggering the geofence, and the payload associated with the geofence, in the case of the geofence 601 displayed in FIG. 10, a message and associated coupon code are delivered as the payload.

Embodiments of the creation module 233 may save and store the created geofence parameters in a geofence management database 213 or a network accessible database such as a network repository 123, data mart or other data structure. Saving and storing each of the geofences and the configuration settings or parameters (including the geofence's payload) may, in some embodiments, allow for the geofence management system 201 to repeatedly create, update and activate the same geofences periodically. For example, a particular marketing event or special promotion may occur once a week, month, year, etc. A user of the geofence management system 201 may in some embodiments, query or lookup a previously created geofence stored in the geofence management database 213 and load the previously stored configuration settings and parameters into memory device 115 of the geofence management system 201, and update the database entry in the geofence management database 213 to include a newly scheduled starting date, duration and expiration date for the geofence.

Embodiments of the geofence module 203 may further comprise a server module 207. Embodiments of the server module 207 may perform the task of loading or transmitting one or more active geofences to one or more client devices 101. The server module 207 may transmit the geofences (created by the creation module 233) to one or more client devices 101 accessing the geofence management system 201 over the network 120. The client devices 101 connecting to the geofence management system 201 may retrieve, store, download or actively stream the geofence data of the geofences over network 120. The user of the client device 101 may select one or more geofences to download from a list of available geofences in some embodiments, while in alternative embodiments, geofences may be automatically downloaded or managed by the client device 101.

In some embodiments of the geofence system 100, the geofence module 203 may comprise a tracking module 227. The tracking module 227 may identify conditions giving rise to the triggering of a geofence payload being displayed. As a client device 101 impinges on a virtual boundary of the geofences or dwells within the virtual boundaries of the geofences, the tracking module 227 may identify the triggering transition and elicit the transmission of the geofence payload resulting from transition's occurrence. Successfully triggering the geofence may cause the server module 207 to transmit the geofence's payload to the client device 101. For example, the geofence's payload may be a message sent to the client device 101 using push notifications, emails, short messaging service (SMS) data or direct messaging service data.

In some embodiments of the geofence management system 201, the reporting module 212 of the geofence management system 201 may perform the function of transmitting statistical information about the past or presently active geofences and the information collected by the geofence management system 201 during the activation of the geofence. For example, the reporting module 212 may be responsible for transmitting data collected by the tracking module 227. The reporting module 212 may transmit statistics and data that may assist the geofence system 100 or customers using the geofence system 100 with identifying the success or failure of the geofence with targeting a particular set of customers. The report generated by the reporting module 212 may include the identification of the number of interactions users have with each of the geofences, the number of times a user has pre-emptively avoided retrieving the geofence, an increase or decrease in the number transitions with the active geofences, demographic information about users interacting with each of the geofences, the attachment rate or rate at which geofence's payloads were positively or negatively received and/or acted upon by users of a client device 101.

Embodiments of the reporting module 212 may further report the statuses of the geofences and whether or not each geofence is currently active, soon to be active, deactivated or deleted by the deletion module 235. Embodiments of geofences system 100 may select a deletion date for deleting each geofence. Deletion of each geofence may be performed by the deletion module 235 and may occur at a scheduled date or in alternative embodiments, the deletion date may occur automatically at a pre-set time after a geofence's expiration date. A currently active geofence may refer to a geofence that has been created, currently able to be triggered via entering, exiting or dwelling within the virtual boundary of the geofence and the active geofence has not yet reached an expiration date and time. A soon to be active geofence may refer to a geofence that has been created but the parameters of the start date and start time has not yet been fulfilled. A deactivated geofence may refer to a geofence wherein the expiration date and time parameters have been fulfilled, but the data describing the geofence is still stored on the client device 101 and/or geofence management system 201. A deleted geofence, may refer to a geofence that has been removed from the client device 101 and/or geofence management system 201.

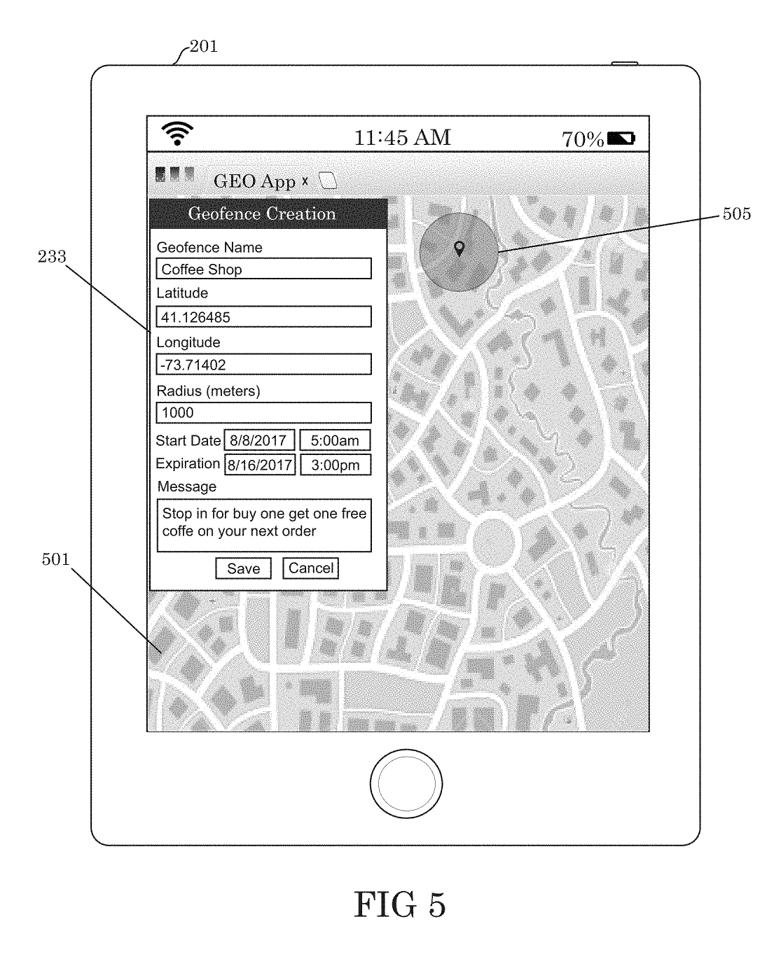

FIG. 5 depicts an example of the geofence creation process in accordance with the geofence management system 201 described above. As shown by the example in FIG. 5, a user of the geofence management system 201 may create a geofence 505 using the geofence creation module 233. During the creation process of the geofence 505, the user may select one or more parameters to define the geofence. As shown by the example, the user may identify the geofence by the name, enter a location (i.e. longitude and latitude of the geofence 505), a size of the geofence (i.e. radius, diameter, etc.) a start date and time, expiration date and time and a geofence payload, in this example the payload may be a message that is displayed by display device 114 of the client device 101 if the client device 101 meets all the requirements for receiving the geofence message of the geofence 505, including entering, exiting or dwelling within the geofence 505 between the start date and expiration date.

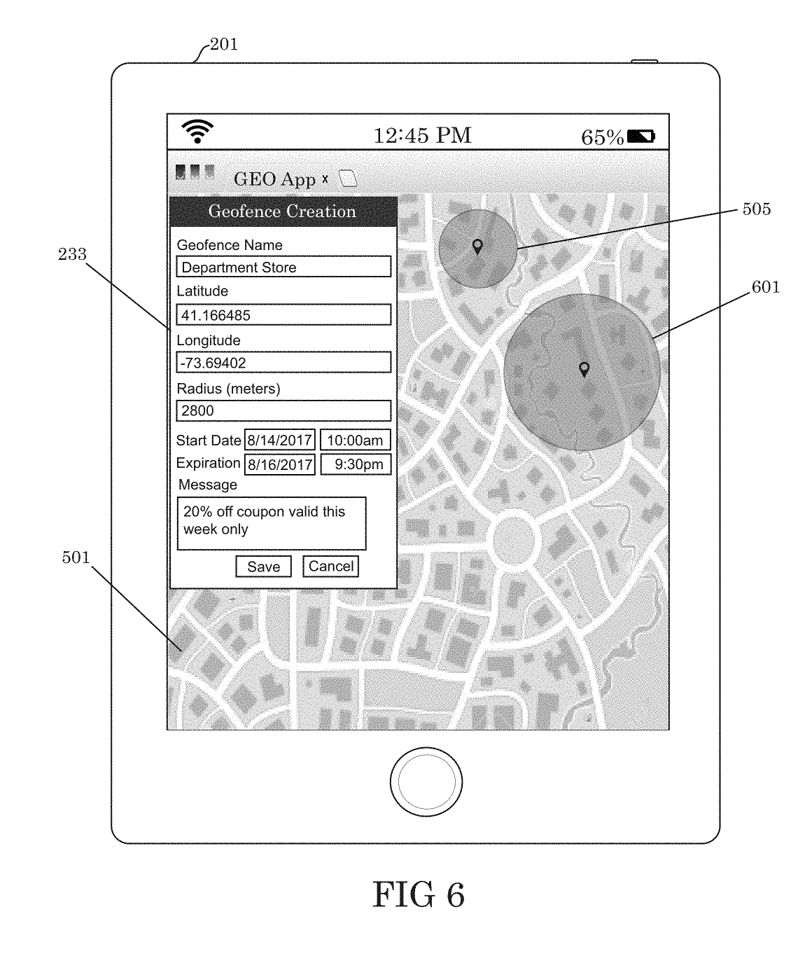

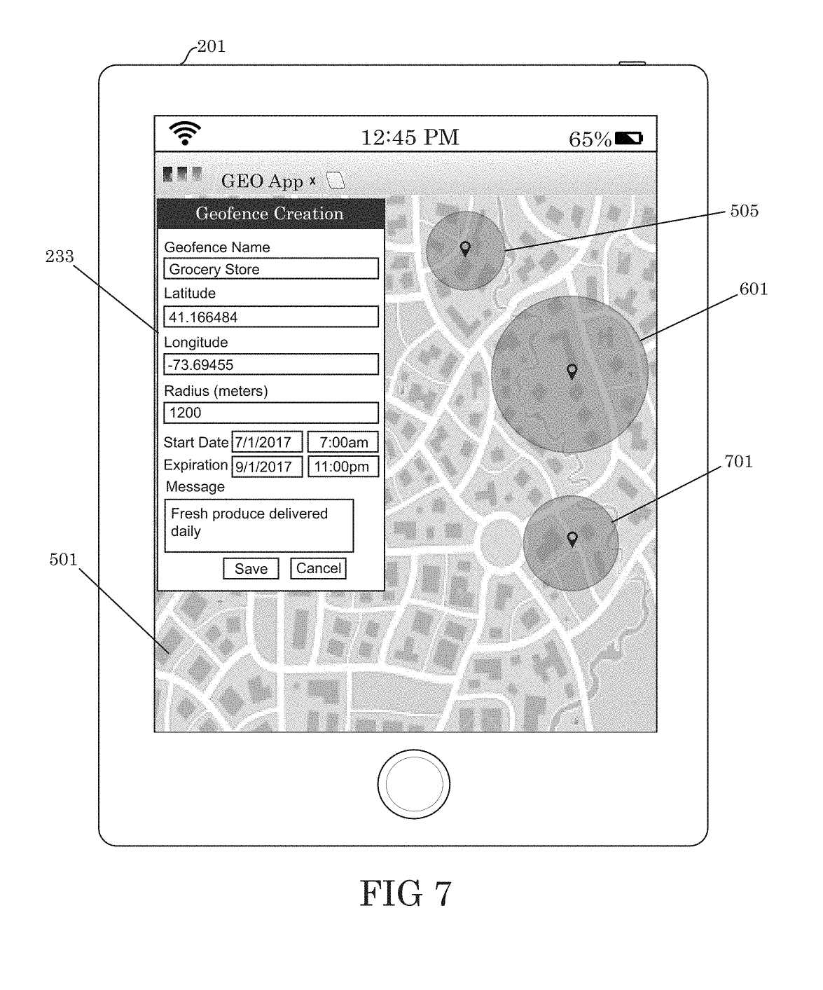

FIG. 6 depicts a second example of a second geofence 601 being created using the geofence creation module 233 while FIG. 7 depicts the creation of a third geofence 701. As shown in the figures, the geofence 505, 601 and 701 may each have a different set of parameters from each other in some embodiments. While in alternative embodiments, the geofences 505, 601 and 701 may share or overlap in some parameters. Example of parameters that may be different, the same or overlapping may include the geofence' name, location (longitude and latitude), size (radius), start date, start time, expiration date, expiration time and/geofence payload.

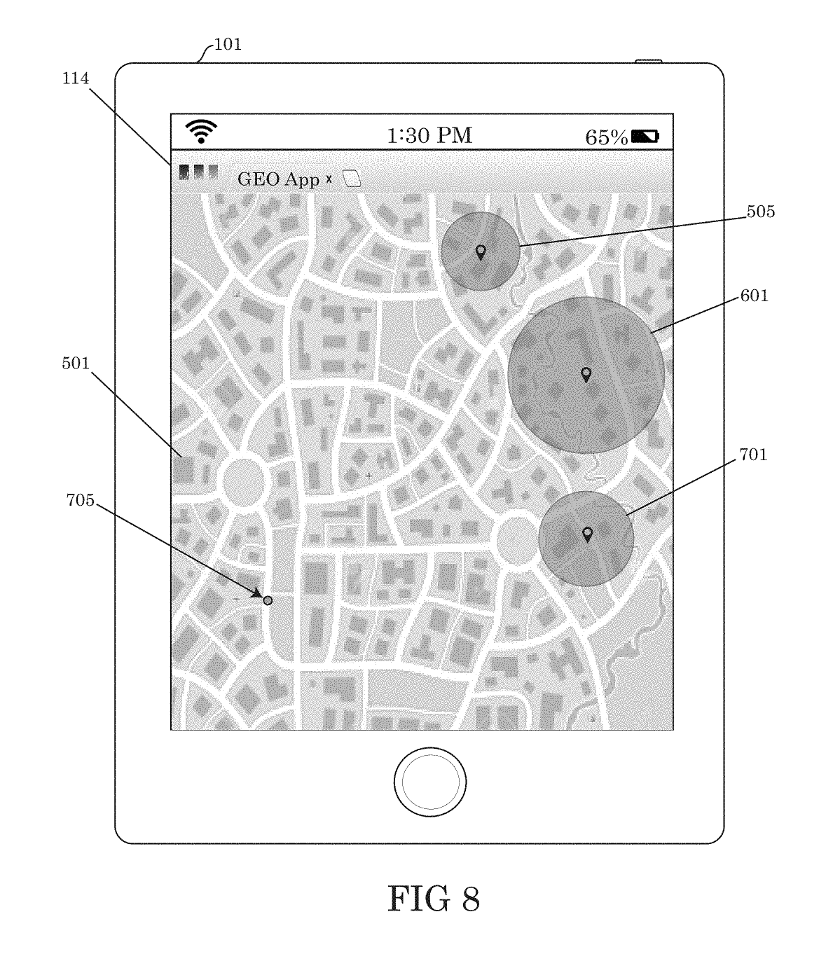

Each geofence created may be mapped to a mapping interface 501 generated by the mapping module 111. As shown in FIG. 8, a plurality of geofences 505, 601, 701 may be created and plotted to a mapping interface 501 simultaneously. Each of the geofences 505, 601 may have different parameters as described above. As shown in FIG. 5-7, each of the geofences 505, 601, 701 may be created to display payload to users that enter, exit or dwell within the geofences. As shown in examples of FIGS. 8-11, one or more of the geofences may not be retrieved or downloaded and/or may be deleted from the client device automatically by the geofence system.

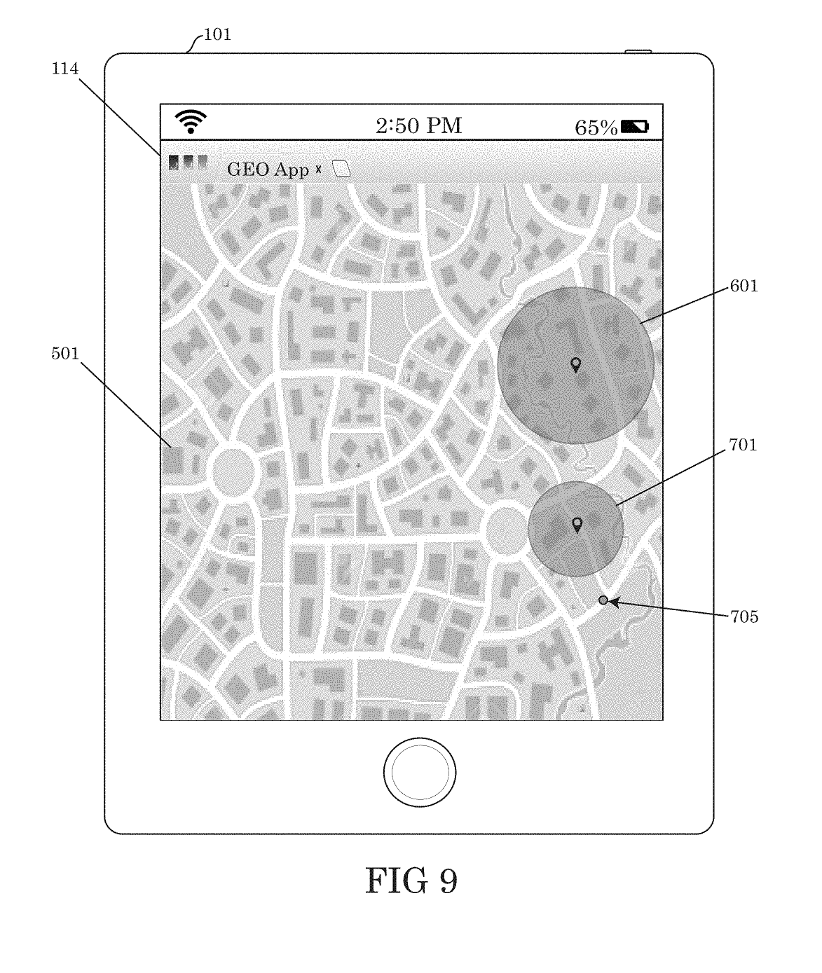

As shown in FIG. 9, geofence 505 is no longer present on the mapping interface 501 of the client device. This may be due to the impracticability or impossibility of a client device being able to reach the geofence before expiration. As shown in FIG. 5, geofence 505 is scheduled to expire at 3:00 pm, in FIG. 9, the current time is 2:50 PM and the current location of the client device is location 705. In the Example of FIG. 9, the client device 101 may have determined that it may not be possible for a client device 101 to travel from location 705 to the location of the geofence 505 boundary within the 10 minutes that remain before expiration. Accordingly, the client device 101 may avoid retrieving the geofence 505 altogether or if geofence 505 was previously retrieved while activating the geofence 505 was previously feasible, the client device 101 may subsequently delete geofence 505 from the client device 101 upon the determination that activating the geofence 505 is no longer a possibility.

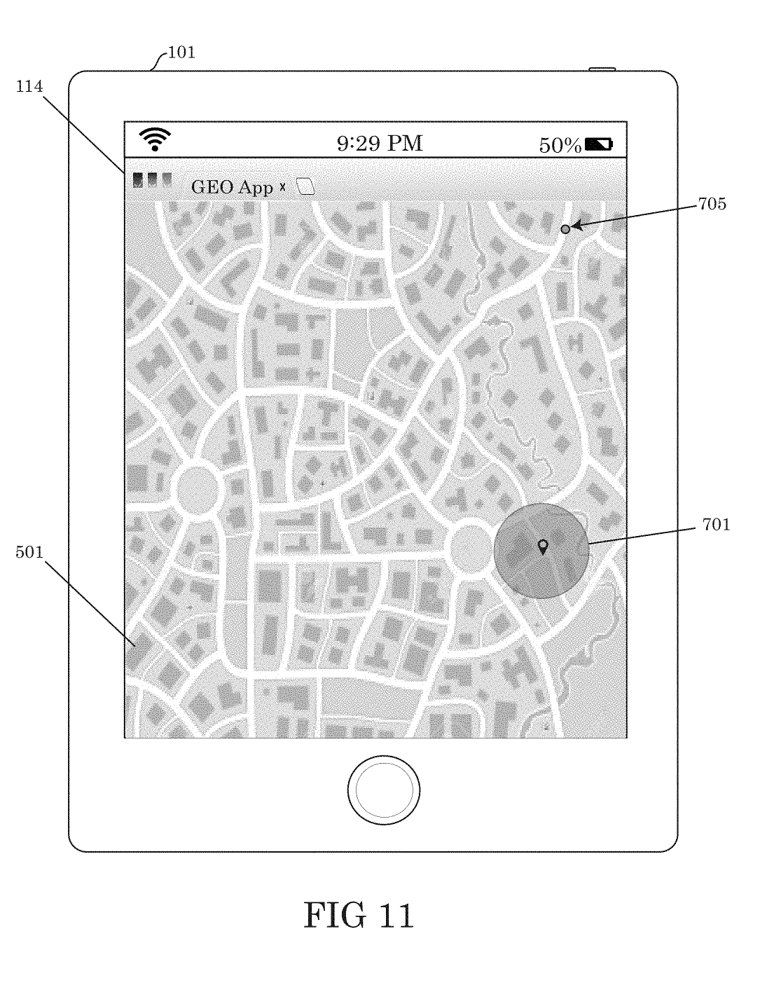

Likewise, in the example shown in FIG. 11, geofence 601 having an expiration time of 9:30 pm is deleted from the mapping interface 501 due to an impractical or impossibility of the client device at location 705 to reach the boundary of geofence 601 before the expiration of the geofence 601 at 9:30 pm. As shown by the client device, the system clock currently displays 9:29 pm. Accordingly, once the system has determined that the client device 101 may not be capable of activating geofence 601 due to the distance and travel speed, the client device 101 may be prevented from retrieving the geofence data of geofence 601 and/or delete geofence 601 from the client device 101.

### Method for Prioritizing Retrieval of Geofences

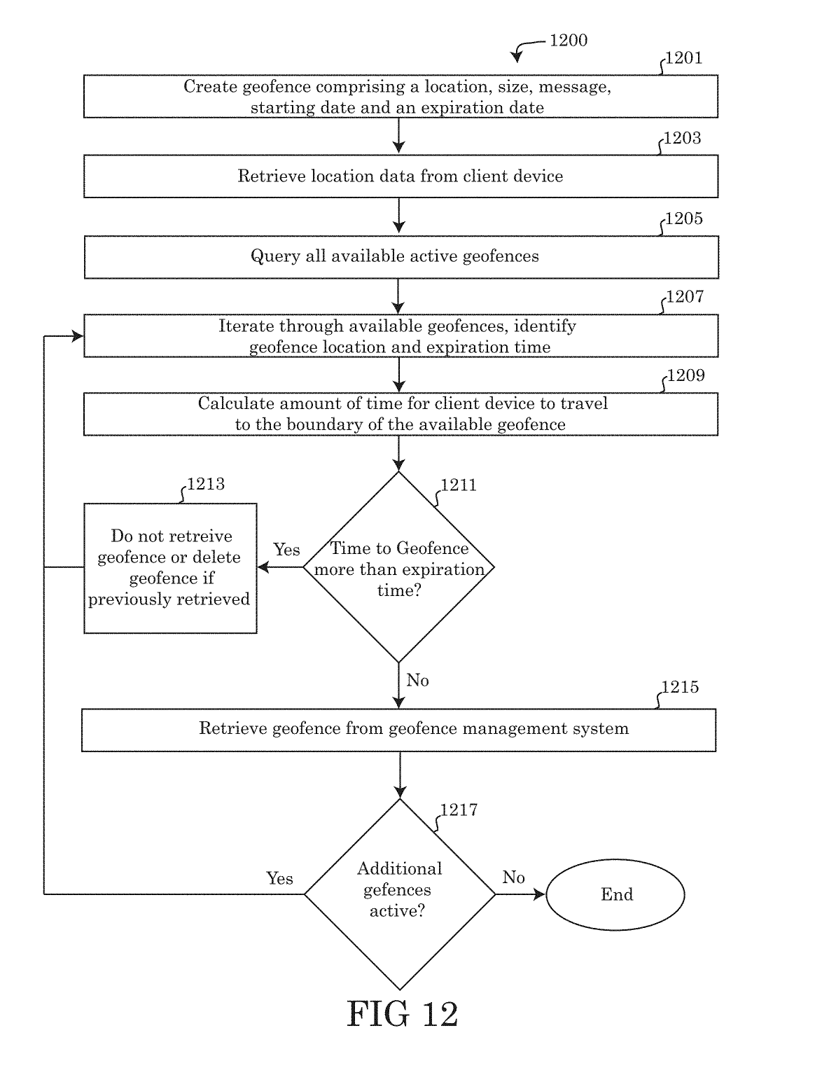

The drawing of FIG. 12 represents an embodiment of a method or algorithm 1200 that may be implemented for prioritizing geofence retrieval based on the ability of the client device 101 to activate the geofence before the expiration of the geofence, in accordance with the geofence system 100, 200 described in FIGS. 1-11, using one or more computer systems as defined generically in FIG. 12 below, and more specifically by the embodiments of specialized computer systems 101, 201 presented in FIGS. 1-11. A person skilled in the art should recognize that the steps of the algorithm 1200 described in FIG. 12 may be performed in a different order than presented by FIG. 12 and the algorithm may not require all the steps described herein to be performed. Rather, some embodiments may alter the geofence notifications using only one or more of the steps discussed below.

The embodiment of the algorithm 1200 for prioritizing geofence retrieval may begin at step 1201. In step 1201, a geofence may be created by the creation module 233 comprising a location, size, geofence payload, starting date, starting time, expiration date and/or expiration time. The created geofence may be saved and stored to a computer storage device such as memory device 115 of the geofence management system 201, a database 213 or a network accessible repository 123.

In step 1203 the client device 101 may periodically retrieve the location data from the location module 105 and the client device may store the location data to the memory device 115, database 113 or network repository 123. In alternative embodiments, the location data retrieved from the location module 105 may be transmitted to the geofence management system 201. Based on the location data of the client device 101, the client device 101 may, in step 1205, query a list of all active geofence that may be nearby and managed by the geofence management system 201. As a function of the query performed in step 1205, the geofence management system 201 may search through one or more records of active geofences which may be stored by database 213 and/or network repository. The server module 207 of the geofence management system 201 may return the results of the query to the client device 101 for further analysis and selection of the active geofences.

In step 1207, the analytics module 110 may iterate through each of the active geofences returned by the geofence management system 201 in response to the query of step 1205. The analytics module 110 may identify each geofence location, the expiration time of each geofence, the current location of the client device 101 as a function of the location data retrieved in step 1203, and collect data from one or more measuring components 107, 108, 109 to estimate a rate of travel being experienced by the client device. In step 1209 of the algorithm 1200, the analytics module 110 may calculate the amount of time that may be needed for the client device to travel to the boundary of each geofence returned by the query in step 1205. The calculation of the traveling time may be estimated as a function of the client device's current location, the location of the geofence, the rate at which the client device 101 is currently traveling (for example, the measured velocity or acceleration). Moreover, in step 1209, the analytics module 119 may further estimate the arrival time of the client device 101 using the system clock module 122 and compare the arrival time with the geofence expiration date and time.

In step 1211, a determination may be made by the geofence system 100 whether the amount of traveling time to the geofence will be greater than the expiration time of the geofence. If the amount of time to travel to the boundary of the geofence will be greater than the expiration time (i.e. the arrival of the client device will occur after the geofence expires), the algorithm may proceed to step 1213, wherein the client device 101 does not retrieve or download the geofence from the geofence management system 201. Some instances wherein the client device 101 has previously downloaded the geofence, the client device 101 may delete the geofence from the client device's computer storage systems, such as database 113, memory device 115, network repository 123, etc.

Conversely, if in step 1211, of the algorithm 1200, the analytics module 110 determines that the traveling time required to move to the location of the geofence would be less than the expiration time of the geofence (i.e. the client device will arrive boundary of the geofence before expiration thereof), the algorithm may proceed to step 1215, wherein the client device retrieves the geofence from the geofence management system 201. For example by requesting the server module 207 to transmit the geofence over network 120 to the client device 101, wherein the client device 101 stores the geofence in the memory device 115 of the client device 101. The algorithm 1200 may proceed to step 1217 and determine if there are any additional geofences to examine and determine whether or not the client device 101 should retrieve the geofence data from the geofence management system 201. If there are additional geofences returned in the query performed in step 1205, the algorithm 1200 may return to step 1207 and iterate through the next geofence returned in the query. Otherwise, the algorithm 1200 may end.

### Computer System

Referring to the drawings, FIG. 13 illustrates a block diagram of a computer system 1300 that may be included in the systems of FIGS. 1-11 and for implementing methods for prioritizing geofence retrieval and deletion as described in the algorithms of FIG. 11 and in accordance with the embodiments described in the present disclosure. The computer system 1300 may generally comprise a processor 1391, otherwise referred to as a central processing unit (CPU), an input device 1392 coupled to the processor 1391, an output device 1393 coupled to the processor 1391, and memory devices 1394 and 1395 each coupled to the processor 1391. The input device 1392, output device 1393 and memory devices 1394, 1395 may each be coupled to the processor 1391 via a bus 1390. Processor 1391 may perform computations and control the functions of computer 1100, including executing instructions included in the computer code 1397 for tools and programs for prioritizing geofence retrieval and deletion in the manner prescribed by the embodiments of the disclosure using the systems of FIGS. 1-11 wherein the instructions of the computer code 1397 may be executed by processor 1391 via memory device 1395. The computer code 1397 may include software or program instructions that may implement one or more algorithms for implementing the methods for prioritizing geofence retrieval and deletion, as described in detail above and in FIG. 12. The processor 1391 executes the computer code 1397. Processor 1391 may include a single processing unit, or may be distributed across one or more processing units in one or more locations (e.g., on a client and server).

The memory device 1394 may include input data 1396. The input data 1396 includes any inputs required by the computer code 1397, 1398. The output device 1393 displays output from the computer code 1397, 1398. Either or both memory devices 1394 and 1395 may be used as a computer usable storage medium (or program storage device) having a computer readable program embodied therein and/or having other data stored therein, wherein the computer readable program comprises the computer code 1397, 1398. Generally, a computer program product (or, alternatively, an article of manufacture) of the computer system 1300 may comprise said computer usable storage medium (or said program storage device).

Memory devices 1394, 1395 include any known computer readable storage medium, including those described in detail below. In one embodiment, cache memory elements of memory devices 1394, 1395 may provide temporary storage of at least some program code (e.g., computer code 1397, 1398) in order to reduce the number of times code must be retrieved from bulk storage while instructions of the computer code 1397, 1398 are executed. Moreover, similar to processor 1391, memory devices 1394, 1395 may reside at a single physical location, including one or more types of data storage, or be distributed across a plurality of physical systems in various forms. Further, memory devices 1394, 1395 can include data distributed across, for example, a local area network (LAN) or a wide area network (WAN). Further, memory devices 1394, 1395 may include an operating system (not shown) and may include other systems not shown in the figures.

In some embodiments, rather than being stored and accessed from a hard drive, optical disc or other writeable, rewriteable, or removable hardware memory device 1394, 1395, stored computer program code 1398 (e.g., including algorithms) may be stored on a static, non-removable, read-only storage medium such as a Read-Only Memory (ROM) device 1399, or may be accessed by processor 1391 directly from such a static, non-removable, read-only medium 1399. Similarly, in some embodiments, stored computer program code 1397 may be stored as computer-readable firmware 1399, or may be accessed by processor 1391 directly from such firmware 1399, rather than from a more dynamic or removable hardware data-storage device 1395, such as a hard drive or optical disc.

In some embodiments, the computer system 1300 may further be coupled to an input/output (I/O) interface (for example I/O interface 117) and a computer data storage unit (for example a data store, data mart or repository 113, 123). An I/O interface 117 may include any system for exchanging information to or from an input device 1392 or output device 1393. The input device 1392 may be, inter alia, a keyboard, joystick, trackball, touchpad, scanning device, bar code reader, mouse, sensors, beacons, RFID tags, microphones, recording device, biometric input device, camera, timer, etc. The output device 1393 may be, inter alia, a printer, a plotter, a display device 114 (such as a computer screen or monitor), a magnetic tape, a removable hard disk, a floppy disk, etc. The memory devices 1394 and 1395 may be, inter alia, a hard disk, a floppy disk, a magnetic tape, an optical storage such as a compact disc (CD) or a digital video disc (DVD), a dynamic random access memory (DRAM), a read-only memory (ROM), etc. The bus 1390 may provide a communication link between each of the components in computer 1300, and may include any type of transmission link, including electrical, optical, wireless, etc.

The I/O interface may allow computer system 1300 to store information (e.g., data or program instructions such as program code 1397, 1398) on and retrieve the information from a computer data storage unit (not shown). Computer data storage units include any known computer-readable storage medium, which is described below. In one embodiment, computer data storage unit may be a non-volatile data storage device, such as a magnetic disk drive (i.e., hard disk drive) or an optical disc drive (e.g., a CD-ROM drive which receives a CD-ROM disk).

As will be appreciated by one skilled in the art, in a first embodiment, the present invention may be a method; in a second embodiment, the present invention may be a system; and in a third embodiment, the present invention may be a computer program product. Any of the components of the embodiments of the present invention can be deployed, managed, serviced, etc. by a service provider able to deploy or integrate computing infrastructure with respect to prioritizing geofence retrieval and deletion. Thus, an embodiment of the present invention discloses a process for supporting computer infrastructure, where the process includes providing at least one support service for at least one of integrating, hosting, maintaining and deploying computer-readable code (e.g., program code 1397, 1398) in a computer system (e.g., computer 1300) including one or more processor(s) 1391, wherein the processor(s) carry out instructions contained in the computer code 1397 causing the computer system to prioritize geofence retrieval and deletion. Another embodiment discloses a process for supporting computer infrastructure, where the process includes integrating computer-readable program code into a computer system including a processor.

The step of integrating includes storing the program code in a computer-readable storage device of the computer system through use of the processor. The program code, upon being executed by the processor, implements a method for prioritizing geofence retrieval and deletion. Thus the present invention discloses a process for supporting, deploying and/or integrating computer infrastructure, integrating, hosting, maintaining, and deploying computer-readable code into the computer system 1300, wherein the code in combination with the computer system 1300 is capable of implementing methods for prioritizing geofence retrieval and deletion.

A computer program product of the present invention comprises one or more computer readable hardware storage devices having computer readable program code stored therein, said program code containing instructions executable by one or more processors of a computer system to implement the methods of the present invention.

A computer program product of the present invention comprises one or more computer readable hardware storage devices having computer readable program code stored therein, said program code containing instructions executable by one or more processors of a computer system to implement the methods of the present invention.

A computer system of the present invention comprises one or more processors, one or more memories, and one or more computer readable hardware storage devices, said one or more hardware storage devices containing program code executable by the one or more processors via the one or more memories to implement the methods of the present invention.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method for prioritizing a retrieval of geofences by a client device comprising the steps of:
querying, by a processor of the client device, a list of geofences, wherein each geofence in the list of geofences comprises a location, a size defined by a boundary, a payload and an expiration time;
receiving, by the processor, location data of the client device;
estimating, by the processor, an amount of time for the client device to travel to the boundary of each geofence in the list of geofences, as a function of client device movement, the location data and the expiration time of each geofence; and
retrieving, by the processor, each geofence from the list of geofences having an amount of time for the client device to travel to the boundary of the geofence that is less than or equal to the expiration time of the geofence.

2. The method of claim 1, wherein the step of estimating the amount of time for the client device to travel to the boundary of each geofence further comprises a padding time added to the amount of time for the client device to travel to the boundary of the geofence.

3. The method of claim 1, wherein the step of estimating the amount of time for the client device to travel to the boundary of each geofence is further calculated by a GPS route.

4. The method of claim 1, wherein the step of retrieving includes downloading each geofence from a geofence management system and storing the geofence on the client device.

5. The method of claim 1, further comprising the steps of:
periodically recalculating, by the processor, the amount of time for the client device to travel to the boundary of each geofence retrieved by the client device as a function of the movement of the client device, the location data and the expiration time; and
deleting, by the processor, each geofence retrieved by the client device, having a recalculated amount of time to travel to the boundary of each retrieved geofence that is greater than the expiration time of each retrieved geofence.

6. The method of claim 1, further comprising the steps of:
triggering, by the client device a geofence retrieved by the processor, as a function of traveling to the boundary of the geofence; and
displaying, by the processor, the payload of the geofence retrieved by the processor on a display device of the client device.

7. The method of claim 1, wherein the list of geofences comprises active geofences and soon to be active geofences.

8. The method of claim 1, further comprising providing at least one support service for at least one of creating, integrating, hosting, maintaining, and deploying computer-readable program code in a computer system, where the computer-readable program code in combination with the computer system is configured to implement the steps of querying, receiving, computing, estimating and retrieving.

9. A computer system, comprising:
a processor;
a memory device coupled to the processing unit;
a measuring device or sensor; and
a computer readable storage device coupled to the processor, wherein the storage device contains program code executable by the processing unit via the memory device to implement a method for prioritizing retrieval of geofences comprising the steps of:
querying, by the processor, a list of geofences, wherein each geofence in the list of geofences comprises a location, a size defined by a boundary, a payload and an expiration time;
receiving, by the processor, location data of the computer system;
computing, by the processor, measurements from a measuring device or a sensor, quantifying movement of the computer system;
estimating, by the processor, an amount of time for the computer system to travel to the boundary of each geofence in the list of geofences, as a function of the movement of the computer system, the location data and the expiration time of each geofence;
retrieving, by the processor, each geofence from the list of geofences having an amount of time for the computer system to travel to the boundary of the geofence that is less than the expiration time of the geofence.

10. The system of claim 9, wherein the step of estimating the amount of time for the computer system to travel to the boundary of each geofence further comprises a padding time added to the amount of time estimated.

11. The system of claim 9, wherein the step of estimating the amount of time for computer system to travel to the boundary of each geofence is further calculated by a GPS route.

12. The system of claim 9, wherein the step of retrieving includes downloading each geofence from a geofence management system and storing the geofence on the computer system.

13. The system of claim 9, further comprising the steps of:
periodically recalculating, by the processor, the amount of time for the computer system to travel to the boundary of each geofence retrieved by the computer system as a function of the movement of the computer system, the location data and the expiration time; and
deleting, by the processor, each geofence retrieved by the computer system, having a recalculated amount of time to travel to the boundary of each retrieved geofence that is greater than the expiration time of each retrieved geofence.

14. The system of claim 9, wherein the list of geofences comprises active geofences and soon to be active geofences.

15. A computer program product comprising:
one or more computer readable hardware storage devices having computer readable program code stored therein, said program code containing instructions executable by the one or more central processing units (CPU) of a computer system implement a method for prioritizing retrieval of geofences comprising the steps of:
querying, by the CPU, a list of geofences, wherein each geofence in the list of geofences comprises a location, a size defined by a boundary, a payload and an expiration time;
receiving, by the CPU, location data of the computer system;
estimating, by the CPU, an amount of time for the computer system to travel to the boundary of each geofence in the list of geofences, as a function of movement of the computer system, the location data and the expiration time of each geofence;
retrieving, by the CPU, each geofence from the list of geofences having an amount of time for the computer system to travel to the boundary of the geofence that is less than the expiration time of the geofence.

16. The computer program product of claim 15, wherein the step of estimating the amount of time for the computer system to travel to the boundary of each geofence further comprises a padding time added to the amount of time estimated.

17. The computer program product of claim 15, wherein the step of estimating the amount of time for the client device to travel to the boundary of each geofence is further calculated by a GPS route.

18. The computer program product of claim 15, wherein the step of retrieving includes downloading each geofence from a geofence management system and storing the geofence on the computer system.

19. The computer program product of claim 15, further comprising the steps of:
periodically recalculating, by the processor, the amount of time for the computer system to travel to the boundary of each geofence retrieved by the computer system as a function of the movement of the computer system, the location data and the expiration time; and
deleting, by the processor, each geofence retrieved by the computer system, having a recalculated amount of time to travel to the boundary of each retrieved geofence that is greater than the expiration time of each retrieved geofence.

20. The computer program product of claim 15, wherein the list of geofences comprises active geofences and soon to be active geofences.
